(19) United States
(12) Patent Application Publication
(10) Pub. No.: US 2020/0357035 A1
(43) Pub. Date: Nov. 12, 2020

(54) OMNICHANNEL SHOPPING OF LARGE TICKET ITEMS

(71) Applicant: Wells Fargo Bank, N.A., San Francisco, CA (US)

(72) Inventor: Andres J. Saenz, Redmond, WA (US)

(21) Appl. No.: 16/003,807

(22) Filed: Jun. 8, 2018

(51) Int. Cl. G06Q 30/06; G06Q 40/02; G06Q 10/10; G06Q 30/02; G06T 11/60

(52) U.S. Cl. CPC G06Q 30/0631; G06Q 40/025; H04W 4/021; G06Q 30/0281; G06T 11/60; G06Q 10/1095

(57) ABSTRACT

The innovation disclosed and claimed herein, in one aspect thereof, comprises systems and methods of shopping for large ticket items. The innovation provides a product portal through which a customer can shop for items digitally over an internet. Availability information can be provided regarding the item to the customer. Customer information is received from the customer. The customer information can include financial data. A customer financial capability is determined based on the financial data to determine whether the customer can purchase the item. A dynamic credit offer can be generated based on the customer financial capability and a cost associated with the item such that an alternate item or ancillary items may be offered depending on the customer financial capability. A demonstration is scheduled based on a demonstration availability and the customer availability.

### BACKGROUND

Online shopping has become increasingly ubiquitous. However, certain items, such as large ticket items, are not as conducive to online shopping. Shoppers or customers may desire to have a real life demonstration of the item before purchasing. Customers can also desire to view the item via an online portal before deciding to follow through with a real life demonstration. Further, large ticket items are usually high in cost. Suppliers or stores may want to confirm a customer can afford the large ticket item before devoting time and staff resources to demonstrate item to the customer.

### BRIEF SUMMARY OF THE DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of omnichannel shopping of large ticket items. A method can include providing a product portal through which a customer can shop for items digitally over an internet. Availability information can be provided regarding the item to the customer. Customer information can be received from the customer. The customer information can include financial data. A customer financial capability can be determined based on the financial data to determine whether the customer can purchase the item.

A system of the innovation can include a product portal that facilitates a customer to shop for items digitally over an internet. An inventory component provides availability information regarding the item to the customer. A customer database provides customer information from the customer, the customer information including at least financial data. A credit component determines a customer financial capability based on the financial data to determine whether the customer can purchase the item.

In aspects, the subject innovation provides substantial benefits in terms of shopping for large ticket items. One advantage resides in facilitating larger purchases for customers that usually require an in person demonstration. Another advantage resides in a more efficient use of salesman or demonstrators to know the customer's financial capability before spending resources on a demonstration.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example component diagram of a system of the present innovation.

FIG. 2 illustrates an example component diagram of a credit component.

FIG. 3 illustrates an example component diagram of a demonstration management component.

FIG. 4 illustrates a method for omnichannel shopping for large ticket items.

FIG. 5 illustrates a computer-readable medium or computer-readable device comprising processor-executable instructions configured to embody one or more of the provisions set forth herein, according to some embodiments.

FIG. 6 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” “screenshot,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

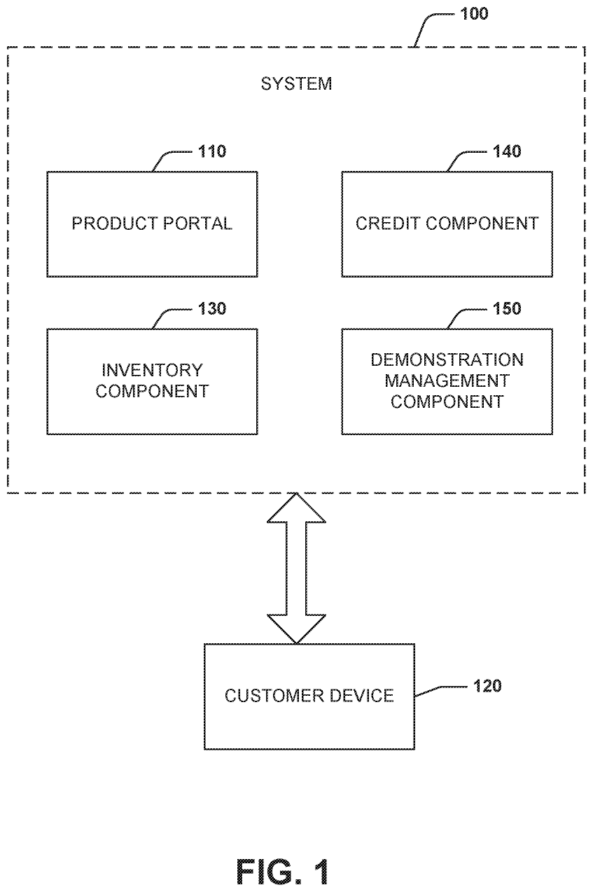

FIG. 1 illustrates a system 100 for omnichannel shopping for large ticket items. The system 100 includes a product portal 110. The product portal 110 facilitates a customer shopping for items digitally over an internet. The product portal 110 provides an online shopping marketplace through which the customer can search, view, and learn items available for purchase via the product portal 110. In some embodiments, the product portal 110 is a website for an online or brick and mortar retailer. In other embodiments, the product portal 110 is associated with a single brick and mortar retailer or a plurality of retailers.

The customer can access the product portal 110 from a customer device 120. The customer device 120 can be a computer, mobile phone, tablet, and/or the like. The customer device 120 renders the items for the customer such that the customer can view pictures, information, item specifications, price, and/or the like. In some embodiments, the customer may utilize multiple devices associated with the customer to interact with the product portal 110. For example, the system 100 can receive a reservation request from a customer device 110 that is a computer and send notifications to another customer device 110 such as is a mobile phone.

In some embodiments, the product portal 120 can complete transactions for the items. In other embodiments, the product portal 120 can facilitate scheduling demonstrations of the items. The product portal 120 can receive a reservation request from the customer device 120 indicating a time, location, item, and/or the like.

The system 100 includes an inventory component 130 that provides availability information regarding the item to the customer via the product portal 110. The inventory component 130 can track item stocks of a plurality of stores and provide the availability information via the product portal 110. The inventory component 130 can update an inventory in real time or near-real time such that the product portal 110 can relay up to date availability information to the customer and the system 100.

The system 100 includes a credit component 140. Upon the system 100 and/or the product portal 110 receives a reservation request, the credit component 130 determines a customer financial capability based on financial data of the customer. The financial capability factors into whether the customer can purchase the item. The credit component 140 receives customer financial data and/or identifying data to determine the customer's financial capability to purchase the item.

In some embodiments, the credit component 140 determines a customer credit score based on the financial data. From the credit score, the credit component 140 determines an amount of financing for which the customer qualifies. In other embodiments, the credit component 140 determines a risk score and/or the like that presents a likelihood that the customer may default on an amount of credit equal to the price of the item. In other embodiments, the credit component 140 determines whether the customer qualifies for a financing amount for the large ticket item based on a cost of the item and the customer financial capability before the system schedules a demonstration of the large ticket item with the customer.

In some embodiments, the credit component 140 can determine that the customer qualifies for a financing amount less than a cost of the item and therefore cannot purchase the item. In this embodiment, the inventory component 130 can determine an alternative item having a cost less than or equal to the determined financing amount. The product portal 110 can communicate the alternative item to the customer via the product portal 110.

In other embodiments, the credit component 140 can determine the customer qualifies for a financing amount that is greater than the cost of the item. In this embodiments, the inventory component 130 can determine an ancillary item having a cost less than or equal to a surplus amount between the financing amount and the cost of the item. For example, the item is a television and the customer qualifies for a financing amount more than the cost of the television. The inventory component 130 can determine peripherals for the television such as a stereo system, cables, extended warranties, and/or the like. The product portal 110 can communicate the ancillary items to the customer via the product portal 110.

The system 100 includes a demonstration management component 150. The demonstration management component 150 receives a reservation request of the item from the customer via that product portal 110. In some embodiments, the reservation request includes a customer availability such as a location, a date, a time, and/or the like. From the reservation request, the demonstration management component 150 determines a demonstration availability for a store or demonstrator location associated with the product portal 110. The demonstration availability includes factors such as demonstrators (e.g. staff) availability, store hours, proximity to customer, and/or the like. The demonstration management component 150 schedules a demonstration based on the demonstration availability and the customer availability. The demonstration management component 150 coordinates matching locations, times, and dates between the customer availability and the demonstration availability.

In some embodiments, the demonstration management component 150 tracks the location of the customer device 120 near a time associated with the scheduled demonstration. The demonstration management component 150 notifies an agent of the store (e.g. a demonstrator, salesman, and/or the like) upon determining the customer is within a predetermined radius of the store. This allows the demonstrator to begin preparing the demonstration for the customer.

In other embodiments, the demonstration management component 150 determines the customer is inside the store. The demonstration management component 150 can generate an augmented reality user interface on the customer device 120. In some embodiments, the augmented reality user interface provides real time directions within the store for the customer to the demonstrator and large ticket item for the demonstration through a screen on the customer device. For example, the augmented reality user interface can overlay route guidance through the store to direct the customer to a demonstration area. In another embodiment, the augmented reality user interface can overlay a virtual demonstration of the item when viewing the item through the customer device.

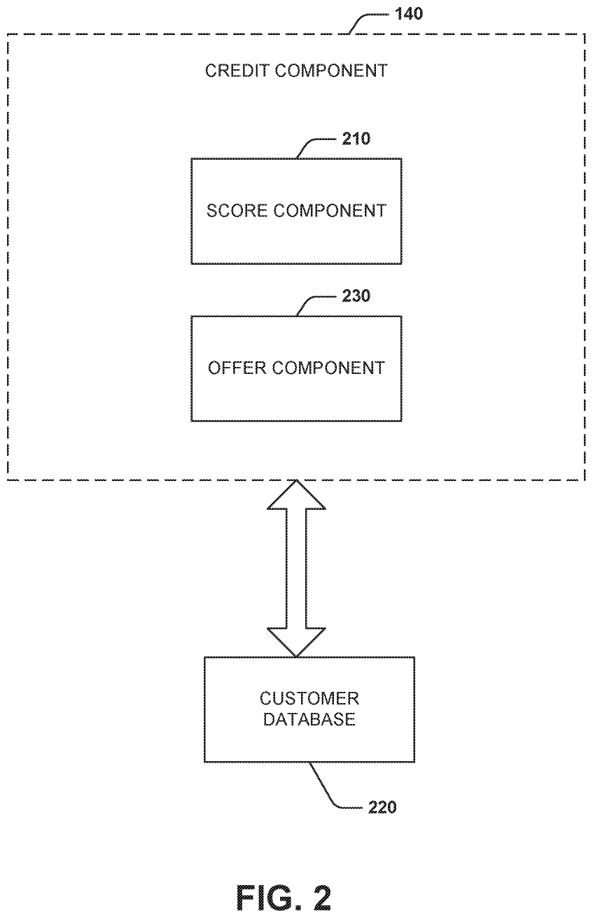

FIG. 2 illustrates a detailed component diagram of the credit component 140. The credit component 140 includes a score component 210. The credit component 140 is sent the reservation request upon the system 100 and/or the product portal 110 receiving a reservation request. The score component 210 determines a customer financial capability based on financial data of the customer. The financial capability factors into whether the customer can purchase the item. The score component 210 receives customer financial data and/or identifying data from a customer database 220 to determine the customer's financial capability to purchase the item and/or alternate items.

In some embodiments, the score component 210 can determine a customer credit score based on the financial data. In other embodiments, the score component 210 receives a customer credit score from a credit bureau, financial institution, and/or the like. In other embodiments, the score component 210 determines a risk score and/or the like that presents a likelihood that the customer may default on an amount of credit equal to the price of the item.

The credit component 140 includes an offer component 230. From the customer financial capability determined by the score component 210, the offer component 230 determines an amount of financing for which the customer qualifies. In some embodiments, the offer component 230 determines whether the customer qualifies for a financing amount for the large ticket item based on a cost of the item and the customer financial capability before the system schedules a demonstration of the large ticket item with the customer.

In some embodiments, the offer component 230 can determine that the customer qualifies for a financing amount less than a cost of the item and therefore cannot purchase the item. In this embodiment, the inventory component 130 can determine an alternative item having a cost less than or equal to the determined financing amount. The product portal 110 can communicate the alternative item to the customer via the product portal 110.

In other embodiments, the offer component 230 can determine the customer qualifies for a financing amount that is greater than the cost of the item. In this embodiment, the inventory component 130 can determine an ancillary item having a cost less than or equal to a surplus amount between the financing amount and the cost of the item. For example, the item is a television and the customer qualifies for a financing amount more than the cost of the television. The inventory component 130 can determine peripherals for the television such as a stereo system, cables, extended warranties, and/or the like. The product portal 110 can communicate the ancillary items to the customer via the product portal 110.

In some embodiments, the offer component 210 considers multiple factors in addition to the cost of the item to determine the amount of financing. The factors may include travel costs, transportation costs, warranty costs, tax implications, and/or the like. For example, the offer component 210 can include the cost of the customer to travel to the store for the demonstration and transport the item in determining the amount of financing to be extended to the customer and whether the customer qualifies for the amount. The offer component 210 can use location data of the customer and store and likely routes between to predict travel costs.

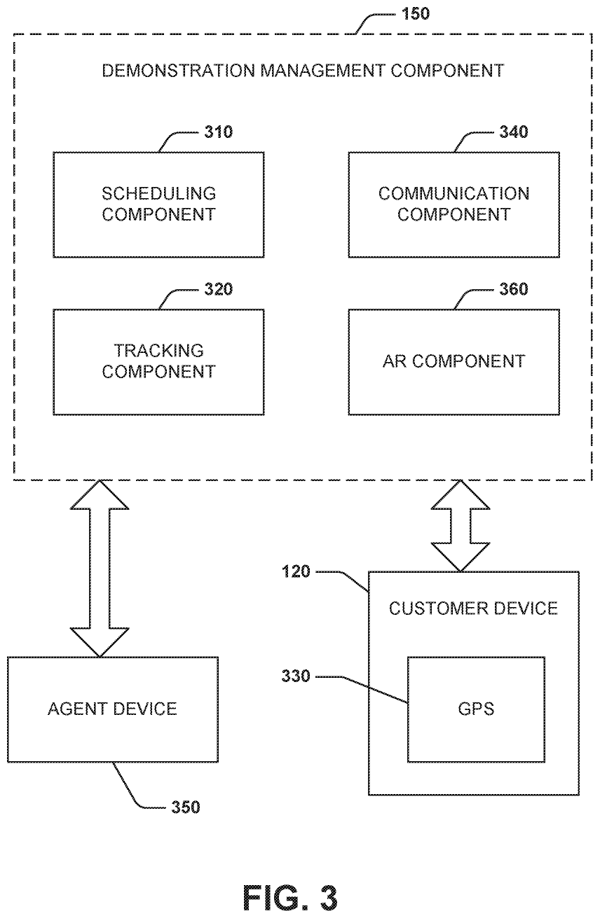

FIG. 3 illustrates a detailed component diagram of a demonstration management component 150. The demonstration management component 150 includes a scheduling component 310 that receives a reservation request of the item from the customer via that product portal 110. In some embodiments, the reservation request includes a customer availability such as a location, a date, a time, and/or the like. From the reservation request, the scheduling component 310 determines a demonstration availability for a store or demonstrator location associated with the product portal 110. The demonstration availability includes factors such as demonstrators (e.g. staff) availability, store hours, proximity to customer, and/or the like. The scheduling component 310 schedules a demonstration based on the demonstration availability and the customer availability. The scheduling component 310 coordinates matching locations, times, and dates between the customer availability and the demonstration availability.

In some embodiments, the demonstration management component 150 includes a tracking component 320 that determines the location of the customer device 120. In some embodiments, the tracking component 320 can be triggered to begin tracking the location of a customer when in a predetermined proximity of a time associated with the scheduled demonstration received from the scheduling component.

The tracking component 320 can interface with the customer device 120 to begin tracking location of the customer. In some embodiments, the customer device 120 can include a global positioning service (GPS) 330 to determine GPS coordinates of the customer device 120. The tracking component 320 can retrieve the GPS coordinates from the GPS 330 to compare in relation to the store and/or demonstration location for tracking.

The demonstration management component 150 can include a communication component 340. In some embodiments, the communication component 340 notifies an agent of the store (e.g. a demonstrator, salesman, and/or the like) upon determining the customer is within a predetermined radius of the store. The communication component 340 notifies the agent on an agent device 350. In other embodiments, the communication component 340 notifies the agent device 350 and/or the customer device 120 within a predetermined time of the scheduled demonstration. The communication component 350 can send multiple notifications at predetermined intervals or times to the agent device 350 and/or the customer device 120.

In other embodiments, the tracking component 320 determines that the customer is inside the store or demonstration area using the GPS 330. The demonstration management component 150 includes an augmented reality component 360 that generates an augmented reality user interface on the customer device 120. In some embodiments, the augmented reality component 360 provides real time directions within the store for the customer to the demonstrator and large ticket item for the demonstration through a screen on the customer device. For example, the augmented reality component 360 can overlay route guidance through the store to direct the customer to a demonstration area. In another embodiment, the augmented reality component 360 can overlay a virtual demonstration of the item when viewing the item through the customer device.

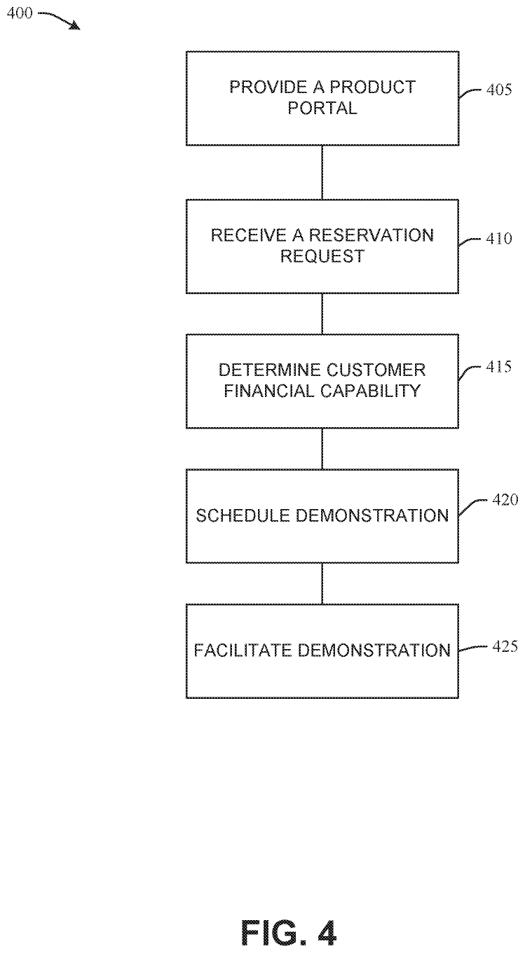

With reference to FIG. 4, example method 400 is depicted for omnichannel shopping of large ticket items. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 400 is described in conjunction with a specific example is for explanation purposes.

FIG. 4 illustrates a method 400 for omnichannel shopping of large ticket items. At 405, a product portal is provided for a customer to shop for items digitally over an internet. The product portal can provide availability information regarding the item to the customer. For example, the product portal is an online website affiliated with a brick and mortar store. A customer can visit the website to shop for large ticket items before going to the store.

At 410, a reservation request is received by the product portal. In the example, the customer can determine they want a live demonstration of a particular large ticket item. The customer can input a reservation request including a location, date, time, and/or the like. In some embodiments, the reservation request can be automatically scheduled after accessing/assessing the customer's digital calendar or availability. In some embodiments, the reservation request can factor in travel times, customer preferences, and/or the like.

At 415, a customer financial capability is determined. The customer financial capability is an objective rubric to determine whether the customer can afford the large ticket item. In some embodiments, the customer financial capability is based on financial data of the customer such as credit score, risk probabilities, current loans/credit, previous credit requests, and/or the like. In the example, the customer's credit score is obtained during a credit check obtained when the customer sends a reservation request. The credit score is factored into determining an amount of credit that can be offered to the customer for financing the large ticket item.

At 420, a demonstration is scheduled for the customer. The demonstration scheduling can be coordinated between store availabilities and the customer submitted reservation request. At 425, coordinate and facilitate demonstration. Notifications can be sent to the demonstrators (store agent, salesman, etc.), and/or the customers based on predetermined settings such as time in relation to the scheduled demonstration. In the example, the demonstrator and the customer can each receive a notification at a time before the demonstration. In some embodiments, the timing is based on a travel time factor for the customer to the location. In other embodiments, the timing is based on a predetermined interval before the scheduled time such as one hour. In some embodiments, an augmented reality user interface can be employed for the customer to direct the customer to the demonstration within the store or facilitate the demonstrator in performing the demonstration.

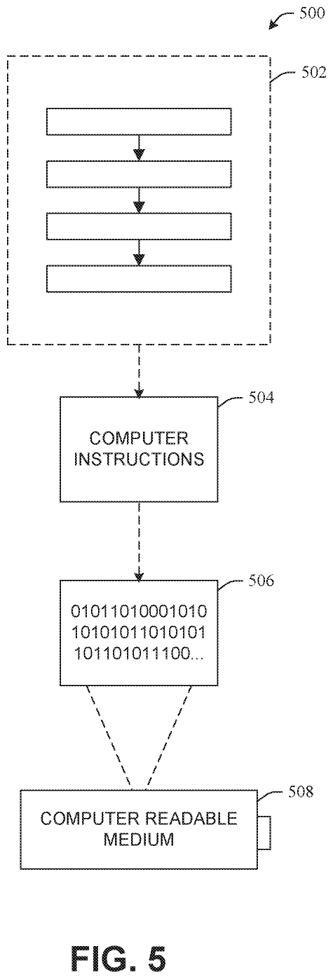

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 5, wherein an implementation 500 comprises a computer-readable medium 508, such as a CD-R, DVD-R, flash drive, a platter of a hard disk drive, etc., on which is encoded computer-readable data 506. This computer-readable data 506, such as binary data comprising a plurality of zero's and one's as shown in 506, in turn comprises a set of computer instructions 504 configured to operate according to one or more of the principles set forth herein. In one such embodiment 500, the processor-executable computer instructions 504 is configured to perform a method 502, such as at least a portion of one or more of the methods described in connection with embodiments disclosed herein. In another embodiment, the processor-executable instructions 504 are configured to implement a system, such as at least a portion of one or more of the systems described in connection with embodiments disclosed herein. Many such computer-readable media can be devised by those of ordinary skill in the art that are configured to operate in accordance with the techniques presented herein.

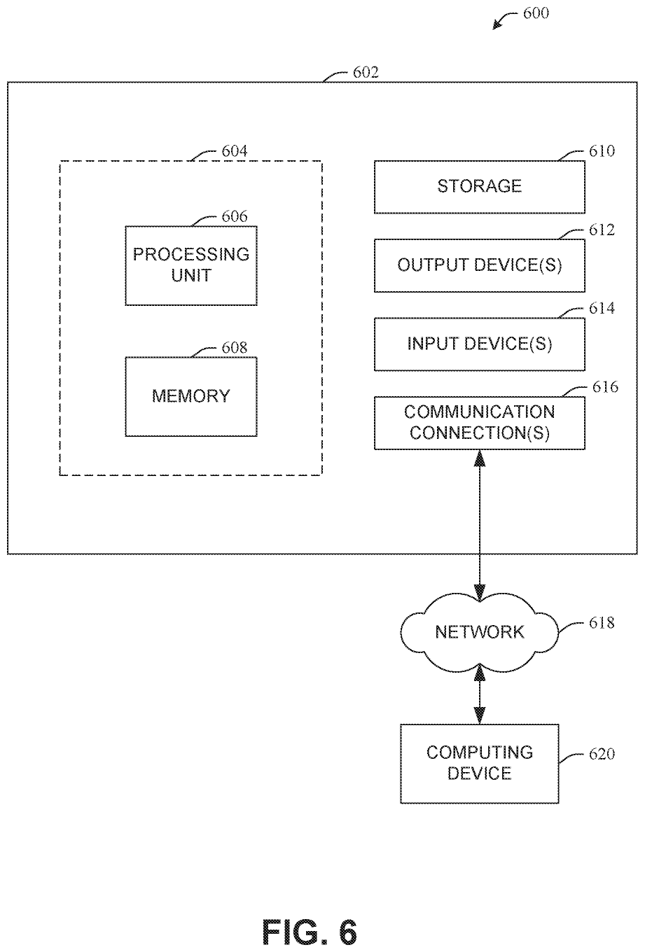

With reference to FIG. 6 and the following discussion provide a description of a suitable computing environment in which embodiments of one or more of the provisions set forth herein can be implemented. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 6 illustrates a system 600 comprising a computing device 602 configured to implement one or more embodiments provided herein. In one configuration, computing device 602 can include at least one processing unit 606 and memory 608. Depending on the exact configuration and type of computing device, memory 608 may be volatile, such as RAM, non-volatile, such as ROM, flash memory, etc., or some combination of the two. This configuration is illustrated in FIG. 6 by dashed line 604.

In these or other embodiments, device 602 can include additional features or functionality. For example, device 602 can also include additional storage such as removable storage or non-removable storage, including, but not limited to, magnetic storage, optical storage, and the like. Such additional storage is illustrated in FIG. 6 by storage 610. In some embodiments, computer readable instructions to implement one or more embodiments provided herein are in storage 610. Storage 610 can also store other computer readable instructions to implement an operating system, an application program, and the like. Computer readable instructions can be accessed in memory 608 for execution by processing unit 606, for example.

The term “computer readable media” as used herein includes computer storage media. Computer storage media includes volatile and nonvolatile, non-transitory, removable and non-removable media implemented in any method or technology for storage of information such as computer readable instructions or other data. Memory 608 and storage 610 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 602. Any such computer storage media can be part of device 602.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 602 can include one or more input devices 614 such as keyboard, mouse, pen, voice input device, touch input device, infrared cameras, video input devices, or any other input device. One or more output devices 612 such as one or more displays, speakers, printers, or any other output device can also be included in device 602. The one or more input devices 614 and/or one or more output devices 612 can be connected to device 602 via a wired connection, wireless connection, or any combination thereof. In some embodiments, one or more input devices or output devices from another computing device can be used as input device(s) 614 or output device(s) 612 for computing device 602. Device 602 can also include one or more communication connections 616 that can facilitate communications with one or more other devices 620 by means of a communications network 618, which can be wired, wireless, or any combination thereof, and can include ad hoc networks, intranets, the Internet, or substantially any other communications network that can allow device 602 to communicate with at least one other computing device 620.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method, comprising:
generating a product portal on a device associated with a customer through which the customer can shop for an item digitally over an internet;
providing availability information regarding the item to the customer via the product portal;
receiving customer information from the customer, the customer information including at least financial data;
determining a customer financial capability based on the financial data to determine whether the customer can purchase the item;
determining a financing amount for which the customer qualifies based on the customer financial capability and, if the financing amount is greater than a cost of the item, communicating, via the product portal, at least one ancillary item having a cost less than or equal to a surplus amount between the financing amount and the cost of the item;
determining a demonstration availability for a store associated with the product portal if it is determined that the customer can purchase the item; and
scheduling a demonstration based on the demonstration availability and availability of the customer.

2. The method of claim 1, wherein determining the customer financial capability comprises:
determining a customer credit score based on the financial data; and
determining an amount of financing for which the customer qualifies.

3. The method of claim 1, comprising:
determining the customer qualifies for a financing amount for the item based on the cost of the item and the customer financial capability; and
scheduling a demonstration of the item with the customer.

4. The method of claim 1, comprising:
determining the customer qualifies for a financing amount less than the cost of the item if it is determined that the customer cannot purchase the item;
determining an alternative item having a cost less than or equal to the financing amount; and
communicating the alternative item to the customer via the product portal.

5. (canceled)

6. The method of claim 1, comprising:
receiving a reservation request of the item from the customer, the reservation request including at least a location, a date, or a time.

7. (canceled)

8. The method of claim 1, comprising:
tracking a location of the customer near a time associated with the scheduled demonstration; and
notifying a demonstrator upon determining the customer is within a predetermined radius of the store associated with the product portal.

9. The method of claim 8, comprising:
determining the customer is inside the store;
generating an augmented reality user interface on a customer device, wherein the augmented reality user interface provides real time direction within the store for the customer to the demonstrator and item for the demonstration.

10. A system, comprising:
a processor and computer instructions stored as executable components in a non-volatile memory comprising:
a product portal rendered on a device associated with a customer that facilitates shopping for an item digitally over an internet;
an inventory component that provides availability information regarding the item to the customer;
a customer database that provides customer information from the customer, the customer information including at least financial data;
a credit component that determines a customer financial capability based on the financial data to determine whether the customer can purchase the item and determines an amount of financing for which the customer qualifies if it is determined that the customer can purchase the item,
wherein the inventory component determines at least one ancillary item having a cost less than or equal to a surplus amount between the financing amount and a cost of the item; and
wherein the at least one ancillary item is communicated to the customer via the product portal; and
a demonstration management component that determines a demonstration availability for a store associated with the product portal if it is determined that the customer can purchase the item; and schedules a demonstration based on the demonstration availability and availability of the customer.

11. The system of claim 10, the credit component further comprising:
a score component that determines a customer credit score based on the financial data.

12. The system of claim 10, comprising:
wherein the credit component determines the customer qualifies for a financing amount for the item based on the cost of the item and the customer financial capability.

13. The system of claim 10, comprising:
wherein if the credit component determines the customer qualifies for a financing amount less than the cost of the item;
the inventory component determines an alternative item having a cost less than or equal to the financing amount; and
wherein the product portal communicates the alternative item to the customer via the product portal.

14. (canceled)

15. The system of claim 10, wherein the demonstration management component receives a reservation request of the item from the customer, the reservation request including at least a location, a date, or a time.

16. (canceled)

17. The system of claim 10, the demonstration management component comprising:
a location component that tracks a location of the customer near a time associated with the scheduled demonstration; and
a communication component that notifies an agent upon determining the customer is within a predetermined radius of the store associated with the product portal.

18. The system of claim 17, the demonstration management component comprising:
wherein the location component determines the customer is inside the store; and
an augmented reality component that generates an augmented reality user interface on a customer device, wherein the augmented reality user interface provides real time direction within the store for the customer to the demonstrator and item for the demonstration.

19. A non-transitory computer readable storage medium having instructions to control one or more processors configured to:
render a product portal that facilitates a customer to shop for an item digitally over an internet on a device associated with the customer;
provide availability information regarding the item to the customer;
provide customer information from the customer, the customer information including at least financial data;
determine a customer financial capability based on the financial data to determine whether the customer can purchase the item;
determine the customer qualifies for a financing amount greater than a cost of the item based on the customer financial capability if it is determined that the customer can purchase the item;
communicate, via the product portal, at least one ancillary item having a cost less than or equal to a surplus amount between the financing amount and the cost of the item;
communicate the at least one ancillary item to the customer via the product portal;
determine a demonstration availability for a store associated with the product portal if it is determined that the customer can purchase the item; and
schedule a demonstration based on the demonstration availability and availability of the customer.

20. The computer readable medium of claim 19, wherein the one or more processors are further configured to:
determine a dynamic credit offer based on the customer financial capability and a cost associated with the item.
